(19) United States
(12) Patent Application Publication
(10) Pub. No.: US 2009/0196123 A1
(43) Pub. Date: Aug. 6, 2009

(54) Collaborative Appointment and Reminder System

(76) Inventor: Rajesh Gautam, Chalfont, PA (US)

Correspondence Address: QUICKPATENTS, INC., 32861 CALLE PERFECTO, SUITE A, SAN JUAN CAPISTRANO, CA, 92675, US

(21) Appl. No.: 12/173,190

(22) Filed: Jul. 15, 2008

Related U.S. Application Data
(60) Provisional application No. 61/026,462, filed on Feb. 5, 2008.

(51) Int. Cl. G04C 13/04

(52) U.S. Cl. 368/52

(57) ABSTRACT

An appointment system for synchronizing disparate electronic calendars of a plurality of remote electronic devices is disclosed. The system includes a primary electronic calendar having a memory for storing information from the remote electronic devices. A processing means processes the information received from remote electronic devices that are connected to an electronic network. The primary electronic calendar utilizes a remote device access means to access each remote electronic device. The primary electronic calendar reads from and writes to each remote electronic calendar through one of the at least one remote device translation means thereby synchronizing the electronic calendar of each remote electronic device with the primary electronic calendar. Appointments, events and reminder maintained on any one of the electronic devices are displayed on all the remote electronic devices associated with the electronic network.

### CROSS-REFERENCE TO RELATED APPLICATIONS

This application claims the benefit of US Provisional Patent Application 61/026,462, filed on Feb. 5, 2008, and incorporated herein by reference.

### STATEMENT REGARDING FEDERALLY SPONSORED RESEARCH AND DEVELOPMENT

Not Applicable.

### FIELD OF THE INVENTION

This invention relates to scheduling systems, and more particularly to a system for synchronizing a plurality of disparate calendars.

### DISCUSSION OF RELATED ART

Many people often fail to remember things that need to be done in near future. As a result, people have been using various methods and devices for reminding themselves about a particular task, meeting, appointment or the like. Cellular phones, MP3 players such as iPod-brand MP3 players, personal computers and web-based applications all provide limited calendar functions. Yet each such device does not typically have provision for synchronizing with a master calendar so that new appointments or changed appointments are automatically updated on every such calendar-including device a person might own.

U.S. Pat. No. 7,340,484 issued to S et al. on Mar. 4, 2008 discloses a system and method that assist in collecting, integrating, and displaying calendar data from a plurality of data source applications. A client connector communicates with a client application. An integrator receives a first calendar data request from two or more of the data source applications through respective data source connectors. The integrator integrates calendar data set and transmits the integrated calendar data set to the client application through the client connector. As the system requires a request for displaying the integrated data, a user may not be reminded if he fails to activate the calendar data request. Such a device does not actively update calendars for the user.

One prior art device, taught in U.S. Pat. No. 5,960,406 to Rasansky on Sep. 28, 1999 discloses a computer system for scheduling events between end users of a system. Each end user is granted a unique password protected personal calendar, which is generated from the information stored in a database at a central server and delivered to each end user as standard HTML sent through the internet. Individuals who use the present system can post reminders to themselves, send announcements to others, and make appointments with others. Such a system has the disadvantage that the custom personal calendar can be viewed only on a standard Web Browser.

Another personal activity scheduling apparatus is taught in U.S. Pat. No. 5,855,006 to Huemoeller on Dec. 29, 1998. Such a system accesses data from various sources to provide a user with information that is required to enable the user to schedule activities conveniently and expeditiously without requiring access to other sources of information. Each of these temporarily-based activities can be associated with data representative of information required by the user to schedule an activity from a list of potential activities into the individual's personal calendar. This is a software-based system that makes use of a display and input/output capabilities of a personal computer, laptop, notebook or other data processing system. This has the disadvantage that the user can access information only through a single device and it is sometimes inconvenient to carry such a device.

U.S. Pat. No. 5,129,057 to Strope on Jul. 7, 1992 teaches a method of simultaneously displaying day calendar information on a screen of an interactive terminal of an information handling system along with data being processed by an application program. The day calendar data is displayed in a first view port and the application program is displayed in a second view port. The device does not facilitate the setting of a reminder. Moreover, a user may unable to carry such an information handling system along with him.

Therefore, there is a need for a system that synchronizes disparate electronic calendar of a plurality of different types of electronic devices. Further, such a device would actively remind the user about a particular task, meeting, appointment or the like. The needed system would render notifications to the user, irrespective of the location, through an associated electronic device. Moreover, such a system would work with various disparate devices and web services that belong to a single person. The present invention accomplishes these objectives.

### SUMMARY OF THE INVENTION

The present invention is an appointment system for synchronizing disparate electronic calendars of a plurality of remote electronic devices. The system includes a primary electronic calendar having a memory for storing information from the remote electronic devices. A processing means processes the information received from the remote electronic devices. Each remote electronic device is connected to an electronic network and information is passed to and from the primary electronic calendar through a connection, which is established between the electronic network and the primary electronic calendar.

The primary electronic calendar utilizes a remote device access means to access calendar of each remote electronic device. The primary electronic calendar reads from and writes to each remote electronic calendar through one of the at least one remote device translation means. This synchronizes the electronic calendar of each remote electronic device with the primary electronic calendar.

A plurality of electronic devices may be connected to the electronic network. Appointments, events and reminders maintained on any one of the electronic devices are displayed on all the remote electronic devices associated with the electronic network. Information from a plurality of source systems can be accessed through various ways.

The present system synchronizes disparate electronic calendars of a plurality of different types of electronic devices. Further, such a device can actively remind the user about any particular task, meeting, appointment or the like. The electronic devices may be portable and easy to carry, or based within a desktop computer system. Moreover, such a system works for various disparate devices and web services that belong to a single person. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a diagrammatic representation of a system for synchronizing electronic calendars of a plurality of electronic devices;

FIG. 2 is a functional block diagram of a device where the system is installed and the device directly communicating with a plurality of source systems;

FIG. 3 is a functional block diagram of a device where the system is installed and the device communicating with a central system;

FIG. 4 is a functional block diagram of a device where the system is installed and the device communicating with a plurality of source systems that communicate with another source system; and

FIG. 5 is a functional block diagram of a device where the system is installed and the system communicating with a central system that communicates with a plurality of source systems, which in turn communicate with another source system.

### DETAILED DESCRIPTION OF THE PREFERRED EMBODIMENT

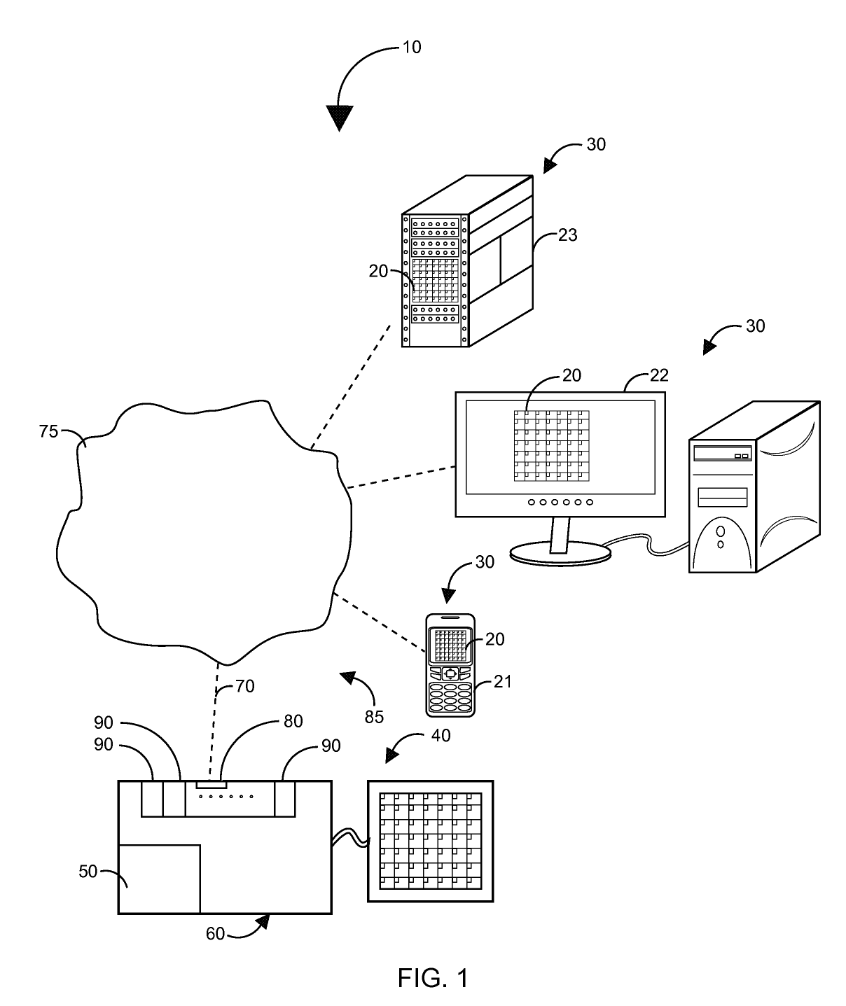

FIG. 1 shows a system 10 for synchronizing disparate electronic calendars 20 of a plurality of remote electronic devices 30 such as a cellular phone 21, personal computer 22, web-based calendar application 23 or the like. The system 10 has a primary electronic calendar 40. The primary electronic calendar 40 has a memory 50 for storing information from remote electronic devices 30. A processing means 60 processes the information received from remote electronic devices 30. Each of a plurality of remote electronic devices 30 is connected to an electronic network 75 and information is passed to and from the primary electronic calendar 40 through a connection 70that is established between the electronic network 75 and the primary electronic calendar 40.

The remote electronic devices 30 connected to the electronic network 75 utilize a network access means 80 to exchange data between the memory 50 of the primary electronic calendar 40 and the remote electronic devices 30. The primary electronic calendar 40 utilizes a remote device access means 85 to access each of the plurality of remote electronic devices 30 when connected to the electronic network 75. The remote device access means 85 includes the network access means 80. The primary electronic calendar 40 reads from and writes to each of the plurality of remote electronic calendars 20 through one of an at least one remote device translation means 90. This synchronizes the electronic calendar 20 of each of the plurality of remote electronic devices 30 with the primary electronic calendar 40. The remote electronic devices 30 may be a cellular phone 21, a personal computer 22 and a web-based calendar application 23 (FIG. 1).

A plurality of electronic devices 30 may be connected to the electronic network 75. Appointments, events and reminders maintained on any one of the electronic devices 30 are displayed on all the remote electronic devices 30 associated with the electronic network 75.

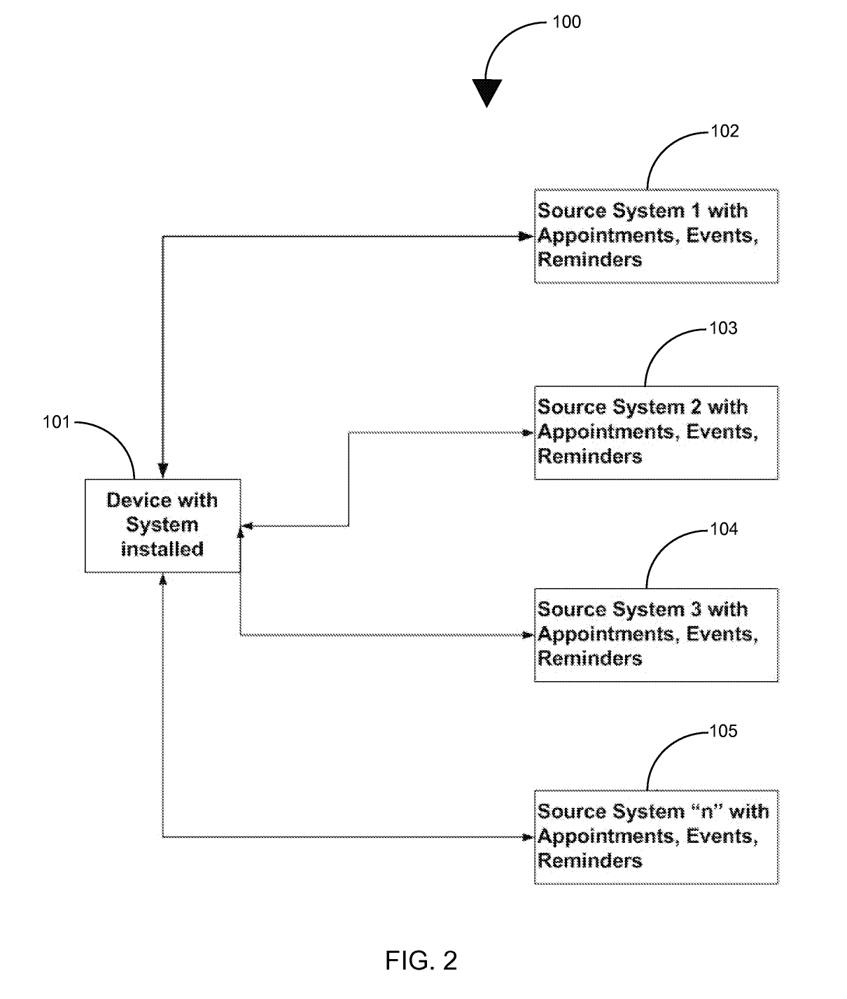

Information from a plurality of source systems 102, 103, 104, and 105 can be accessed through various ways 100, 110, 120, and 130. In one way, a device with the system 101 installed directly communicates with all sources of information 102, 103, 104, and 105. In this case, a user may configure the system 10 locally and provides all authentication information (FIG. 2).

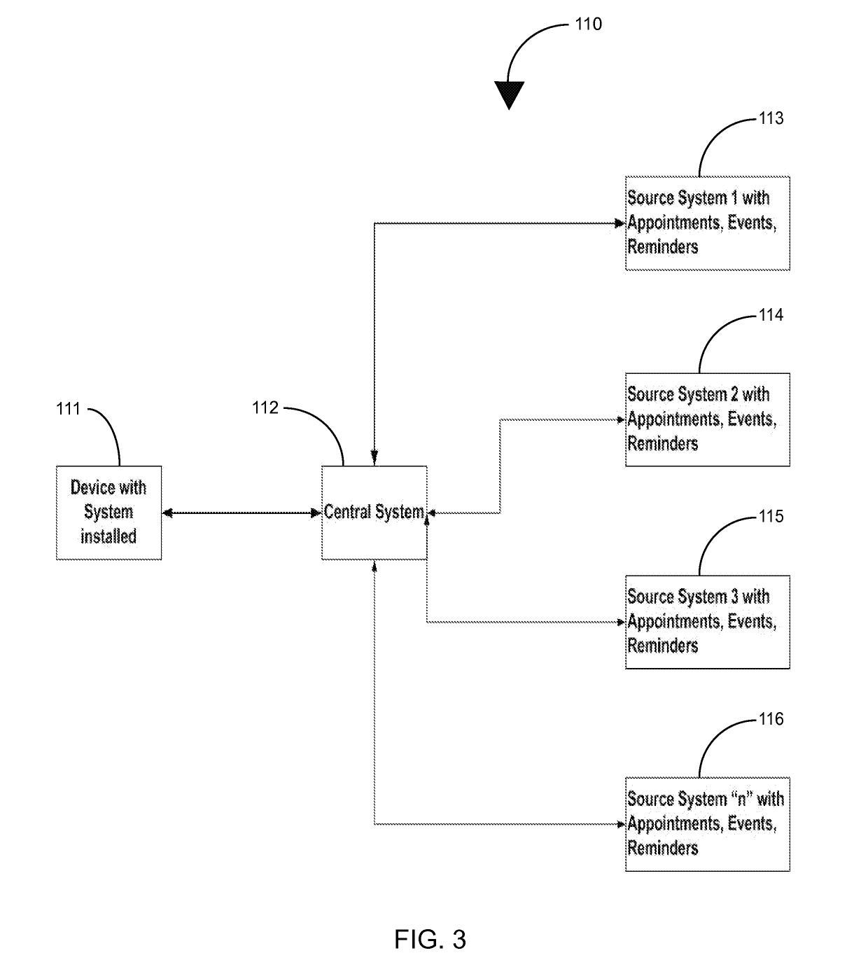

Another way of communication between a plurality of source systems 113, 114,115, and 116 and a device 111 with the system installed is through a central system 1 12. User authentication information for all source systems 113, 114,115, and 116 is stored in a central system 112. The central system 112 after authentication establishes a communication with all source systems 113, 114,115, and 116 and shares the information with every device 111 with the system installed (FIG. 3).

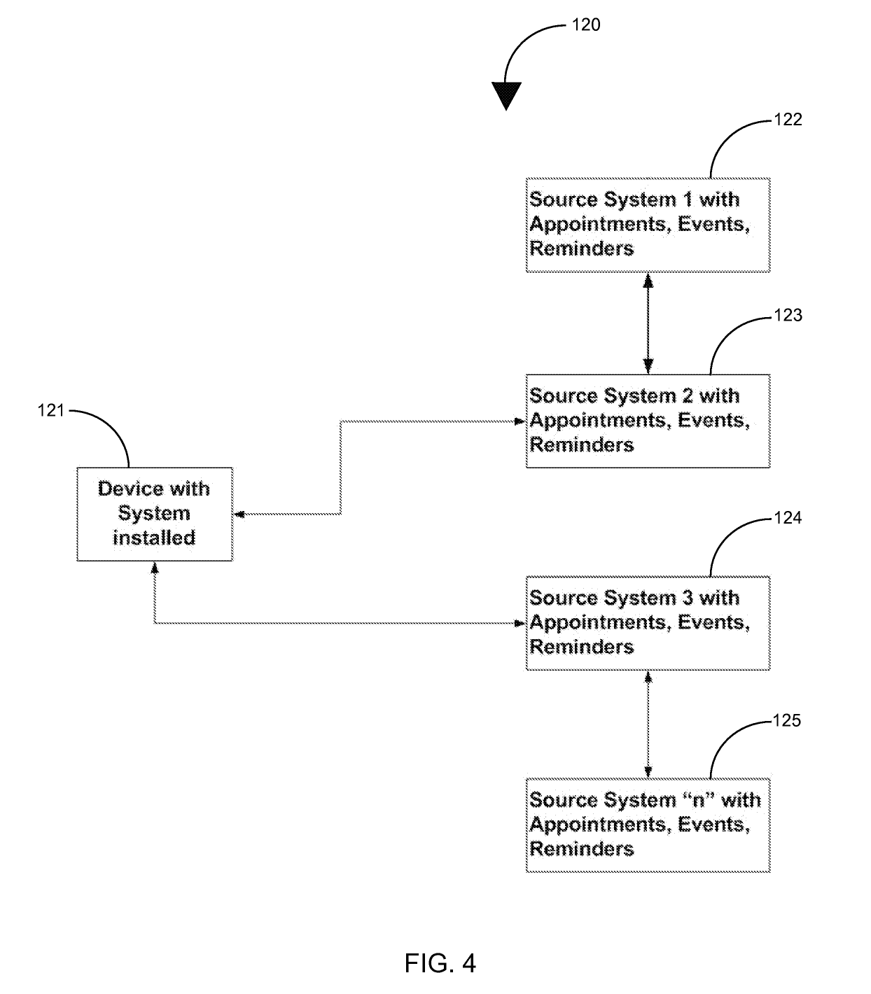

Further, a device with the system installed 121 directly communicates with source systems 123 and 124 wherein each source system 123 and 124 are in communication with another source system 122 and 125 respectively (FIG. 4).

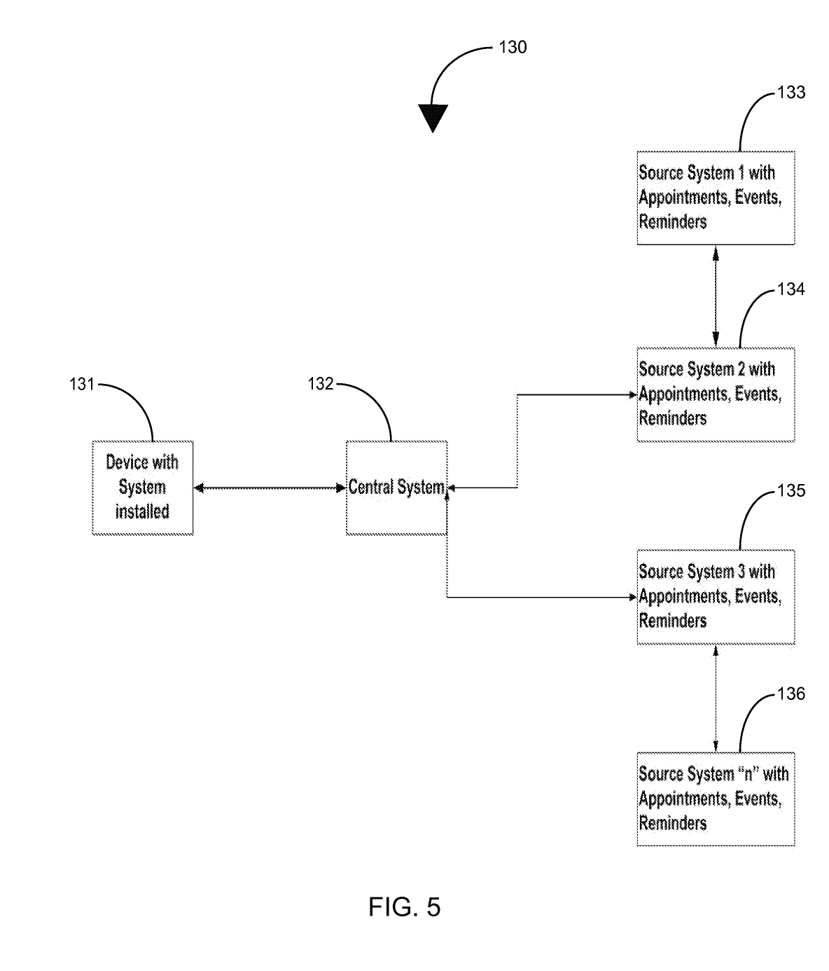

In addition, source systems 134 and 135 are in communication with another source system 133 and 136 respectively. The source systems 134 and 135 communicates with a central system 132, and any device with the system installed 131 communicates with the central system 132 (FIG. 5).

While a particular form of the invention has been illustrated and described, it will be apparent that various modifications can be made without departing from the spirit and scope of the invention. For example, various remote device access means 85 and device translation means 90 may be employed. Accordingly, it is not intended that the invention be limited, except as by the appended claims.

What is claimed is:

1. A system for synchronizing a plurality of electronic calendars, each of a remote electronic device, comprising:
a primary electronic calendar comprising a memory, a processing means, a connection to an electronic network, a network access means, and at least one remote device translation means;
whereby each remote electronic device, while connected to the electronic network, may connect to and utilize the network access means of the primary electronic calendar to read from and write to the memory of the primary electronic calendar through one of the at least one device translation means to synchronize the electronic calendar of the remote electronic device with the primary electronic calendar.

2. The system of claim 1 wherein at least one of the electronic devices is a cellular phone.

3. The system of claim 1 wherein at least one of the electronic devices is a personal computer.

4. The system of claim 1 wherein at least one of the electronic devices is a web-based calendar application.

5. A system for synchronizing a plurality of electronic calendars, each of a remote electronic device, comprising:
a primary electronic calendar comprising a memory, a processing means, a connection to an electronic network, a remote device access means, and at least one remote device translation means;
whereby the primary electronic calendar may utilize the remote device access means to access each remote electronic device when each remote electronic device is connected to the electronic network, the primary electronic calendar reading from and writing to each remote electronic calendar through one of the at least one device translation means to synchronize the electronic calendar of each remote electronic device with the primary electronic calendar.

6. The system of claim 5 wherein at least one of the electronic devices is a cellular phone.

7. The system of claim 5 wherein at least one of the electronic devices is a personal computer.

8. The system of claim 5 wherein at least one of the electronic devices is a web-based calendar application.
